(19) United States
(12) Patent Application Publication
(10) Pub. No.: US 2022/0009669 A1
(43) Pub. Date: Jan. 13, 2022

(54) METHOD FOR PRODUCING A PACKAGING HAVING A CIRCUMFERENTIAL EDGE FLANGE AND A BARRIER FILM

(71) Applicant: AR Packaging GmbH, Kriftel (DE)

(72) Inventor: Ralf Mack, Königsbrunn (DE)

(73) Assignee: AR Packaging GmbH, Kriftel (DE)

(21) Appl. No.: 17/374,418

(22) Filed: Jul. 13, 2021

(30) Foreign Application Priority Data
Jul. 13, 2020 (EP) 20 185 472.6

(51) Int. Cl. B65D 5/32; B65B 7/28; B65D 5/20; B65D 1/34; B65D 5/24; B65D 5/56; B65D 5/60; B65D 77/20

(52) U.S. Cl. CPC B65D 5/321; B65B 7/2878; B65D 5/2047; B65D 5/2076; B65D 77/2024; B65D 5/243; B65D 5/563; B65D 5/603; B65D 1/34

(57) ABSTRACT

A method for producing packaging comprises providing the shell part that defines an opening, a cavity at least partially formed by a bottom wall and side walls, and a continuously circumferential lower contact surface at a constant height around the opening of the cavity and providing a collar including the circumferential edge flange. At least one bottom tool is structured to comprise aa lower contact surface and a cavity configured to receive the shell part. At least one top tool is structured to comprise an upper contact surface. The shell part is inserted into the cavity of the at least one bottom tool and the collar is placed on the lower contact surface. A barrier film is placed over the edge flange and pressed to form a tray that is filled with goods. A sealing film is then pressed against the barrier film to seal the goods within the tray.

### CROSS REFERENCE TO RELATED INVENTION

This application is based upon and claims priority to, under relevant sections of 35 U.S.C. § 119, European Patent Application No. 20 185 472.6, filed Jul. 13, 2020, the entire contents of which are hereby incorporated by reference.

### FIELD OF TECHNOLOGY

The invention relates to a method for producing packaging made of cellulose-containing flat material having a circumferential edge flange and a barrier film.

### BACKGROUND

Shells (trays), plates, cups and other packaging having a circumferential edge flange made of cardboard, cellulose-containing flat material and a barrier film or other barrier layer for gas, water vapor, aroma or grease for storing foods are known. They are used, for example, in modified atmosphere packaging (MAP), in which foods are packaged using nitrogen, carbon dioxide or another inert gas in order to increase the shelf life of the food in the unopened packaging. In other applications of such containers, the foods are vacuum-packed in order to improve the shelf life. In both packaging methods, in addition to gas-tightness, a moisture barrier is desired in order to avoid moisture loss of the food.

Rectangular shells formed from a blank made of cardboard, which have a bottom wall, side walls and flanges on the outer edges of the side walls, are known. Two corner connecting tabs are in each case arranged between neighboring side walls at the corners. In the erect state of the shell, the neighboring corner connecting tabs are folded against one another and against the inside of a neighboring side wall. The edge flanges have flange portions which overlap one another in order to form a completely circumferential edge flange. Such a shell is illustrated, for example, in the ECMA Code of Folding Carton Design Styles under code D 20.20.21.62 and, equipped with a barrier layer, is described for example in EP 3 604 154 A2. The disadvantage is that when a sealing film or another cover is applied to the edge flange in the region of the overlaps of multiple plies of the flange material, channels can be formed, meaning that the packaging is not airtight. The process of compensating for the different material thicknesses at the edge flange by tools which are adapted thereto for sealing the cover onto the shell is already known.

EP 2 441 697 B1 describes a method for producing a packaging for modified atmosphere packaging (MAP packaging), in which a plastic film is laminated onto a folding box and, as a result of this, the folding box maintains its shape. Adjacent wall parts and adjacent flange parts of the folding box abut one another in each case such that overlaps are avoided. As a consequence, all flange parts are arranged in a single plane and a sealing film can be sealed thereon in an airtight manner. The disadvantage is that the production of the shell is complex since, for this purpose, the blank has to be held precisely erect until the barrier film adheres. This limits the production speed.

WO 99/67143 A2 describes a food packaging having a circumferential edge flange, which is lined on the inside with a plastic film, in particular a plastic composite film, which grasps the edge flange, and the inner space of said food packaging is closed or sealed in a gas-tight, in particular oxygen-tight manner, over the edge flange by means of a lid film. The packaging comprises a shell part which at least partially forms the packaging base and the side walls, and a continuous collar which forms the edge flange placed on said shell part. When the packaging is sealed, the continuous surface of the edge flange, which is covered by the plastic film of the lining, makes it possible to seal the lid film as extensively as possible. The working speed of the packaging machine can be increased without the risk of capillary-like radial channels being created between the lid film and the lining film, which are detrimental to long-term airtightness. The circumferential edge flange can in addition be used to stabilize the packaging tray. The collar can be attached to the side walls of the shell part by means of tabs or can be firmly connected to angled edge flange segments of the side walls of the shell part.

WO 2020/033350 A1 describes a container for receiving a food product, which has a base layer and a liner at least partially attached to the inner surface of the base layer. A continuously circumferential flange is connected to walls on the front side at inner edges located opposite one another via fold lines. Furthermore, the flange is connected to side walls at outer edges located opposite one another via fold lines and connecting tabs, and these are connected to bottom walls via fold lines. The connecting tabs contact the undersides of flange portions located opposite one another, and are bonded thereto. The side walls are folded downward and the bottom walls are folded against one another and bonded to one another. Finally, the walls on the front side are folded downward in order to close the shell at its ends. The liner is laminated on the top side of the shell. The edge flange has different wall thicknesses since the flange portions adjacent to the side walls are two-ply and the flange portions adjacent to the walls on the front side are single-ply.

Packaging for different applications is executed with different thicknesses. Thus, shell (trays) which are filled with sandwiches can be executed with a lower thickness than shells which are filled with ready meals (convenience food).

Different tools are used for the production of packaging of different thicknesses and/or shapes. These are in particular adapted to the edge flanges of the respective packaging such that they equalize different thicknesses of various flange portions of the edge flange in order to achieve a uniform contact pressure on the circumferential sealing surface. If the thickness of the packaging changes, the compensation in the region of the edge flange is no longer correct such that another tool has to be used.

### BRIEF SUMMARY OF THE INVENTION

Starting therefrom, the object of the invention is to provide a method for producing packaging having a circumferential edge flange made of cellulose-containing flat material with a barrier film, in which method the outlay for the production and packaging of different thickness is reduced.

An embodiment of method for producing packaging having a circumferential edge flange comprises forming shell parts from cardboard, paperboard, corrugated board, paper or other cellulose-containing flat material, which at least partially form a bottom wall and side walls of trays, and collars made of cardboard, paperboard, corrugated board or paper, which can be placed on said shell parts and which each have a flat, continuously circumferential edge flange of uniform thickness. At least one bottom tool is provided having a cavity is configured for receiving the shell part with an opening at the upper end and a flat, continuously circumferential lower contact surface at a constant height around the opening of the cavity and configured for supporting the edge flange all-over. At least one top tool is provided having a flat, continuously circumferential upper contact surface at a constant height and adapted to the lower contact surface. One of the shell parts is inserted into the cavity and one of the collars is placed with the edge flange on the lower contact surface of the bottom tool. A barrier film is arranged above the collar and the shell part so that it covers the edge flange. The barrier film is pressed against the top side of the collar and of the shell part and is connected thereto to form a tray, which is then filled with goods. A sealing foil is arranged above the tray so that it covers the edge flange and is pressed by means of the top tool in a continuously circumferential manner against the top side of the barrier film on the edge flange and is connected to said barrier film in a sealing manner, while preserving the flat, continuously circumferential edge flange of uniform thickness. Packaging, in which the shell parts differ from one another due to various thicknesses, is produced by means of the same bottom and top tools, and/or packaging, the collars of which differ from one another due to various thicknesses, is produced by means of the same lower and upper tools.

In another embodiment of the method, packaging having various thicknesses is produced by means of the same bottom and top tools (hereinafter: “tools”). There are multiple possibilities in terms of the various thicknesses: in a first embodiment, the packaging differs in that only the shell parts have various thicknesses. In a second embodiment, only the collars of the various packaging differ from one another due to various thicknesses. In a third embodiment, both the thicknesses of the shell parts and the thicknesses of the collars of various packaging differ from one another, wherein the thicknesses of the shell parts and of the collars of the respective packaging can be identical or different. The various embodiments are made possible by the fact that, prior to forming the trays, the shell parts and collars are separated from one another. Furthermore, the barrier film can be pressed against the top side of the shell part and of the collar by applying a vacuum to the underside of the shell part, such that the barrier film is pressed on independently of the respective thicknesses of the collar and of the shell part. In addition, the barrier film can be pressed against the top side of the edge flange by means of a top tool such that it is connected particularly firmly thereto. Due to the flat, continuously circumferential edge flange of uniform thickness, no compensation by the bottom tool and/or the top tool is required in order to press the barrier film firmly and uniformly onto the edge flange. Furthermore, the use of the same tools is made possible by the fact that due to the flat, continuously circumferential edge flange of uniform thickness, no compensation by the bottom tool and/or the top tool is required in order to press the sealing film onto the barrier film on the edge flange such that it seals uniformly. Thanks to the flat, continuously circumferential lower contact surface of the bottom tool at a constant height which is configured for supporting the edge flange all-over and the flat, continuously circumferential upper contact surface of the top tool at a constant height which is adapted to the lower contact surface, a uniform pressing of the barrier film onto the edge flange or of the sealing film onto the barrier film on the edge flange is of course constantly achieved, irrespective of the thickness of the collar used in each case. As a result of the barrier film being pressed uniformly onto the edge flange and the sealing foil being pressed uniformly onto the barrier film on the edge flange, the creation of small channels between the barrier film and sealing film is avoided. If applicable, the path of the feed of the top tool to the bottom tool only needs to be modified to adapt to the thickness of the respective collar in the sense that, in the event of a thicker collar, a slightly smaller feed path is set and, in the event of a less thick collar, a slightly larger feed path is set. The first embodiment can in particular be used if the tray, which is unmodified in other respects, has to be filled with products having weighed portions which differ considerably from one another. The second embodiment can in particular be used if it comes down to a particularly stable collar. This can be the case, for example, if multiple packages are stacked on top of one another or the packaging is held on lateral guide rails with the collar such as, e.g., in production or during storage in catering trolleys. The third embodiment can in particular be used if the requirements of the first embodiment and the second embodiment are to be jointly met.

According to an embodiment, the tray is a round tray or a polygonal tray. The method can be particularly advantageously utilized for the production of round trays since, due to the lack of wall thickness compensation by the bottom tool and/or the top tool, the shell parts and collars can be inserted in various orientations. This advantage also comes into play in the case of polygonal trays, in particular if they have identical edge lengths. For the production of any trays, it is advantageous if the method requires a lower accuracy when inserting the shell part and the collar into the bottom tool, due to the lack of a necessity to compensate for various wall thicknesses, such that the production speed can be increased.

According to a further embodiment, the barrier film is pressed against the top side of the collar and of the shell part by applying a vacuum to the underside of the shell part and is connected to said collar and shell part to form a tray. By applying a vacuum, the barrier film can be squeezed sufficiently firmly against the collar and shell part and can be connected thereto. In the event that this connection is not sufficient to prevent the barrier film from detaching from the edge flange when the sealing film is loosened from the barrier film, the barrier film is pressed against the top side of the edge flange by means of the top tool and is connected to said top side when the barrier film is pressed against the top side of the collar and of the shell part, according to a further embodiment. As a result, a particularly firm connection between the barrier film and edge flange is achieved.

According to a further embodiment, the barrier film is squeezed against the top side of the shell part and collar by means of a punch of a top tool, which is shaped in a corresponding manner to the top side of the shell part and of the collar, in order to connect the barrier film to the shell part and the collar. In this embodiment, the application of a vacuum can be dispensed with. The barrier film can be squeezed against the top side of the edge flange at the same time by means of the punch. However, it is also possible that the top tool, in addition to the punch, has a frame for pressing the barrier film against the top side of the edge flange in order to produce a higher contact pressure for pressing the barrier film onto the edge flange than for pressing the barrier film onto the remaining parts of the collar and the shell part.

According to a further embodiment, the shell parts and/or the collars have an adhesive surface made of a pressure-sensitive and/or heat-sensitive varnish or adhesive, and the bonding between the shell part and collar is produced by compressing the shell part and collar by means of the punch. In the case of a heat-sensitive varnish or adhesive, the punch can be heated for this purpose.

According to a further embodiment, the cavity and the shell part are configured in such a way that the shell part sits with its underside on a surface of the bottom tool, which delimits the cavity, when the shell part is inserted into the cavity. The bracing of the shell part on the underside is advantageous for pressing the barrier film against the top side of the shell part. In addition, this makes it possible to insert the shell part and the collar separately from one another into the bottom tool and to connect them to one another by means of the barrier film and/or the pressure-sensitive and/or heat-sensitive varnish or adhesive. In another embodiment, the shell part and the collar are connected to one another prior to being inserted into the bottom tool. In this embodiment, the shell part can in principle also engage in the bottom tool without bracing itself on a surface of the bottom tool. This makes it possible to produce trays by means of the same tools, which differ from one another due to the dimensions of the shell parts.

According to a further embodiment, the shell parts are conical such that the distance of side walls of the shell part, which are located opposite one another, from one another becomes greater as the distance from the bottom wall increases and the cavity is configured in a correspondingly conical manner, as a result of which the shell part sits with the underside of its side walls on surfaces of the bottom tool, which delimit the cavity. This is advantageous for pressing the barrier film against the top side of the shell part and makes it possible to vary the dimension of the shell part by side walls of different heights, without needing to replace the bottom tool. In addition, this makes it possible to insert the shell part and the collar separately from one another into the bottom tool and to connect them to one another by means of the barrier film and/or the pressure-sensitive and/or heat-sensitive varnish or adhesive.

According to a further embodiment, the cavity and the shell part are configured in such a way that the shell part sits with the underside of its bottom wall on a surface of the bottom tool, which delimits the cavity, when the shell part is inserted into the cavity. This is particularly advantageous for pressing the barrier film against the top side of the bottom wall of the shell part. According to a further embodiment, a bottom tool is provided, which comprises an upper bottom tool part having the circumferential lower contact surface and various lower bottom tool parts having variously sized and/or variously shaped cavities for the shell part, and trays having variously sized and/or variously shaped shell parts are produced with the same upper bottom tool part and the lower bottom tool part which matches the shell part in each case. This makes it possible to produce variously sized and/or variously shaped shell parts by means of a bottom tool which works with the same upper bottom tool part and in which the adaptation to the variously sized and/or variously shaped shell parts is achieved by replacing a lower bottom tool part. This is in particular advantageous in the case or bottom tools which are configured in such a way that a matching shell part sits with the underside of its bottom wall on a surface of the bottom tool, which delimits the cavity.

According to a further embodiment, the barrier film is heated by heat conduction and/or radiation and/or convection prior to and/or during pressing against the shell part and the collar, and/or the sealing film is heated by heat conduction and/or radiation and/or convection prior to and/or during pressing against the barrier film. The barrier film is softened by heating such that it can be stretched and adapted to the surface of the shell part and of the collar and can be connected to said surface. According to a further embodiment, the sealing film is heated, bringing it into a state in which it can be connected in a sealing manner to the barrier film on the edge flange. The sealing film can be heated by heat conduction and/or radiation and/or convection.

According to a further embodiment, the shell part is formed from a blank made of cardboard, paperboard, corrugated cardboard, paper or another foldable flat material or by pressing a cellulose-containing flat material, and/or the collar is formed from a blank made of cardboard, paperboard, corrugated cardboard, paper or another foldable flat material. According to a preferred embodiment, the shell part is formed from a blank made of cardboard. According to a further preferred embodiment, the collar is formed from a blank made of cardboard. According to a further preferred embodiment, the shell part is pressed out of a moist mass of cellulose fibers (molded fiber) or the shell part is pressed out of a flat material which has a core comprising an airlaid made of a cellulose-containing material, at least one cellulose-containing non-woven fabric or paper on at least one side of the core and a coating applied to the non-woven fabric or the paper. One of the cellulose-containing flat materials, which are described in European patent application EP 20 165 163.5, can in particular be used for the shell part. In this regard, reference is made to the aforementioned patent application, the content of which is hereby incorporated into the present patent application.

According to a further embodiment, the barrier film comprises at least one ply made of one of the following materials: PET, PLA, EVOH, PA, PBT, PP, PE, and/or the barrier film is produced from at least one biopolymer and/or the barrier film is produced from at least one renewable raw material and/or the barrier film is produced from at least one compostable raw material. According to a further embodiment, the barrier film is a plastic composite film which has an oxygen barrier layer preferably made of polyvinyl alcohol and a sealing layer preferably made of peelable polyethylene as well as an adherent layer preferably made of a modified polyethylene, in particular a copolymer of ethylene having 6% methacrylic acid, partially (50%) neutralized with Na or zinc ions (SurlynA).

According to a further embodiment, the sealing film is formed by a plastic composite film which has a preferably peelable plastic layer on the side facing the tray, preferably made of polyethylene and, located above it, at least one oxygen-impermeable layer preferably made of polyvinyl alcohol, and a covering heat barrier layer, for example made of polypropylene. The peelable plastic layer of the sealing film promotes targeted removal of the sealing film from the shell part.

The sealing film either forms the entire cover of the tray, or is a film or layer which is laminated or lined onto the underside of a lid, wherein the lid may consist of cardboard, paperboard, corrugated board, paper or another cellulose-containing flat material.

According to a further embodiment, the collars are glued into the shell parts. According to a further embodiment, the collar is glued into the shell part and the shell part with the collar glued therein is inserted into the bottom tool or the shell part is first inserted into the bottom tool and the collar is then inserted into the bottom tool and glued into the shell part.

According to a further embodiment, the shell part has slots or other first connector elements and the collar has tabs with barbed hooks or other second connector elements or vice versa, and a shell part and a collar are in each case connected to one another by slotting together at least one second connector element and one first connector element before the barrier film is pressed against the collar and shell part and connected thereto to form a tray. According to a further embodiment, the plug connection between the collar and the shell part is produced and the shell part and the associated collar are then inserted into the bottom tool.

According to a further embodiment, the shell part and/or the collar are printed on the top side with a coating which influences the adhesion effect of the barrier film, and the barrier film is pressed onto the top side of the collar and of the shell part provided with the coating and is connected to the collar and the shell to form a tray. Thanks to the coating, the adhesion effect of the barrier film can be controlled in such a manner that a targeted removal of the barrier film from the shell part and collar is facilitated following use in order to dispose of these separately from one another. Packaging having a coating which influences the adhesion effect of the barrier film is the subject-matter of the European patent application EP 20 165 163.5 and the European patent application EP 19 214 176.0, the contents of which are hereby incorporated into the present application. Reference is made to the aforementioned patent applications with respect to the coatings which influence the adhesion effect of the barrier film.

According to a further embodiment, the same bottom tool and the same top tool are used for connecting the shell part, collar and barrier film to form a tray, the same bottom tool as previously is used for filling the tray with goods, and the same bottom tool and the same top tool as previously are used for connecting the filled tray to the sealing film. According to another embodiment, the same bottom tool and the same top tool are only used for connecting the shell part, collar and barrier film to form a tray, another bottom tool is used for filling the tray with goods and, in turn, another bottom tool and another top tool are used for connecting the filled tray to the sealing film. In this embodiment, the tray is produced in a first station (lining station), the tray is filled in a second station (filling station) and the filled tray is sealed in a third station (sealing station).

According to a further embodiment, the bottom tool and the top tool each have multiple applications in order to produce multiple trays at the same time and/or to fill them with goods and/or to seal them.

### BRIEF DESCRIPTION OF THE DRAWINGS

The invention is explained in greater detail below with reference to the appended drawings of an exemplary embodiment, wherein:

FIG. 1 illustrates a top perspective view of an embodiment of a shell part and a collar;

FIG. 2 illustrates a perspective top view of an embodiment of a bottom tool having multiple cavities for the simultaneous production of trays;

FIG. 3 illustrates a perspective top view of the embodiment of the bottom tool of FIG. 3 with inserted shell parts and collars as well as a barrier film arranged thereabove; and

FIG. 4 illustrates a sectional view of the sealing of the filled trays with a sealing foil by means of a bottom tool and a top tool.

### DETAILED DESCRIPTION OF THE INVENTION

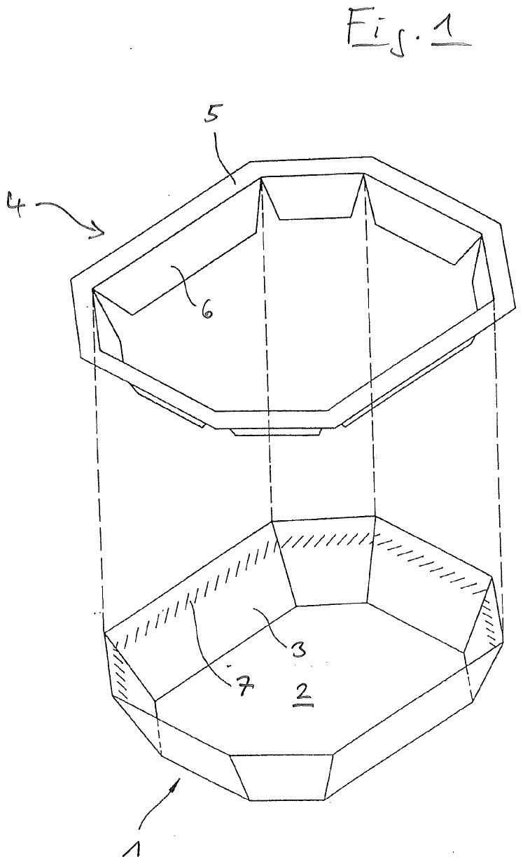

According to FIG. 1, a shell part 1 has a bottom wall 2 and side walls 3 which are each inclined slightly outwards. At the edges, neighboring side walls 3 abut one another. The side walls 3 are trapezoidal, with their width increasing from bottom to top in order to bring about the outward inclination. In the example, the shell part 1 is octagonal.

A collar 4 has a flat, continuously circumferential edge flange 5 of uniform thickness, which likewise has eight sides. Each straight-lined portion of the edge flange has a trapezoidal tab 6 at the inner edge, the width of which decreases from top to bottom.

In FIG. 1, the shell part 1 and the collar 4 are shown in the erect state, in which they are glued together. For this purpose, the collar 4 is placed from above onto the shell part 1 and bonded at the tabs 6 to the adhesive surfaces 7 on the insides of the side walls 3 of the shell part 1.

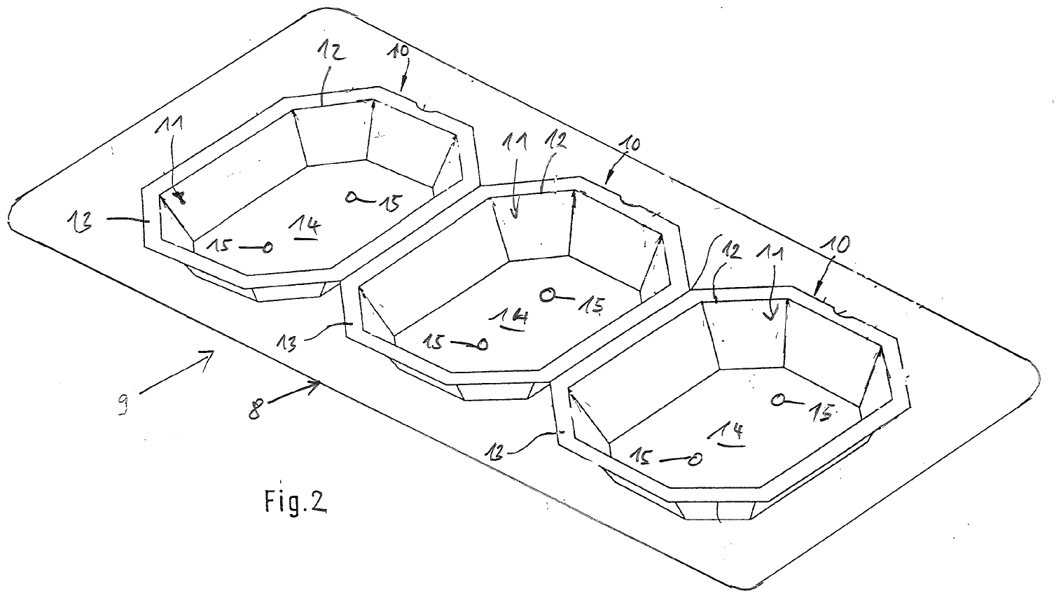

According to FIG. 2, a bottom tool 8 of a laminating station 9 has three applications 10 for simultaneously producing three trays. Each application comprises a cavity 11, the outer shape of which corresponds to the shape of a shell part 1. Furthermore, each application 10 comprises a circumferential contact surface 13 around an upper opening 12 of the cavity 11 for supporting an edge flange 5 of a collar 4.

In a lower delimiting surface 14 of each cavity 11, which corresponds to the bottom wall 2 of a shell part 1, one or more suction openings 15 open out from vacuum channels 11, to which a vacuum pump can be joined.

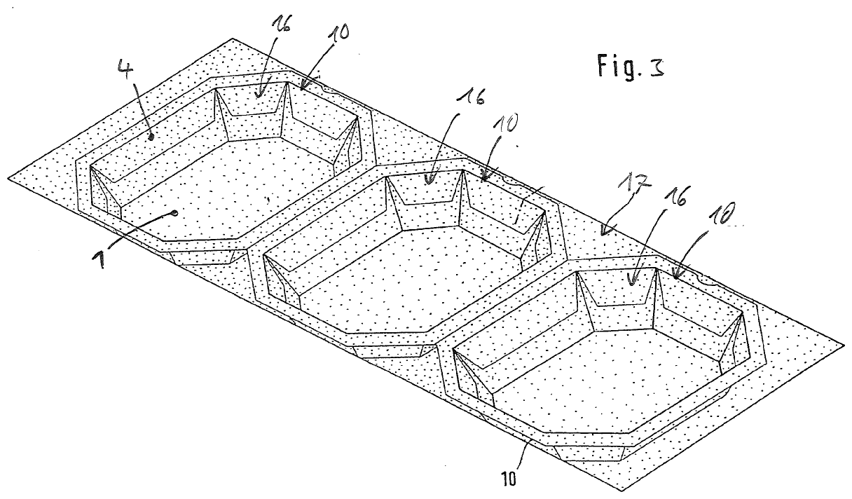

According to FIG. 3, a pre-glued shell 16 made of a shell part 1 with a collar 4 is inserted in each application 10. Furthermore, a barrier film 17 is stretched across all of the applications 10. In this state, the barrier film 17 is heated and pressed against the top sides of the shell part 1 and of the collar 4 by applying a negative pressure to the suction openings 15 and is connected thereto to form a tray 18. The barrier film 17 can be heated by means of a heating apparatus which is not shown. The heating apparatus can be, for example, a hotplate, a radiator or a fan heater. The barrier film 17 can be additionally squeezed against the top side of the edge flange 5 by means of the top tool. For this purpose, the top tool can have a frame which is adapted to the contact surface 13 or the edge flange 5.

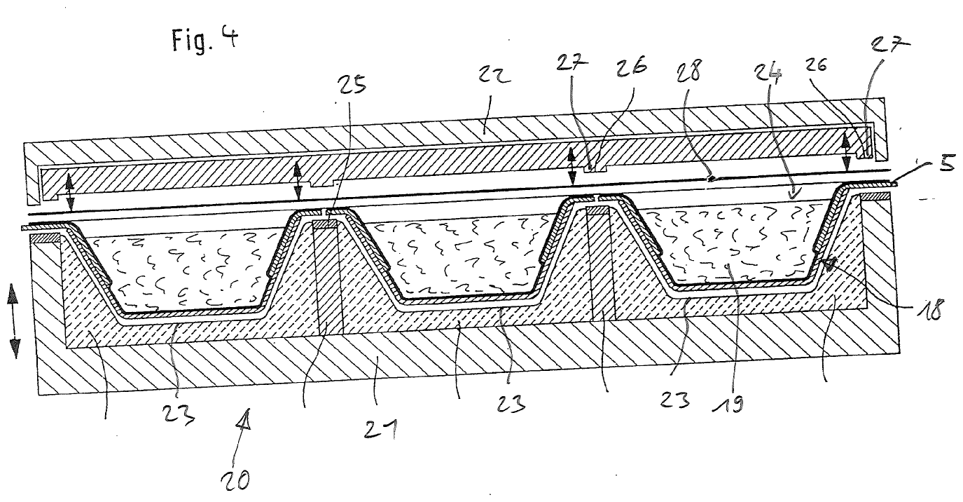

According to FIG. 4, trays 18 prepared in such a way are already filled with goods 19, e.g., with a food or convenience food. The filling can be carried out in a filling station which is arranged upstream of the sealing station 20 shown in FIG. 4.

The sealing station 20 comprises a bottom tool 21 and a top tool 22. The bottom tool 21 likewise has three cavities 23, in which the shell parts 1 of the trays 18 sit, and circumferential lower contact surfaces 25 around the openings 24 of the cavities 23, on which lower contact surfaces the underside of the circumferential edge flanges 5 sit. The top tool 22 has, on the underside, upper contact surfaces 26 on strip-shaped heating apparatuses 27, which extend circumferentially over each edge flange 5. The heating apparatuses 27 cover both adjacent edge flanges 5 on the abutting edge flanges 5 of neighboring trays 18. A sealing film 28 is arranged between the bottom tool 21 and the top tool 22.

The sealing film 28 can be pressed against the edge flanges 5 by means of the top tool 22 and can be heated at the same time such that it is connected to the sealing film 28 on the edge flanges 5. The top tool 22 can be configured in such a way that, after the connection of the sealing foil 28 to the edge flanges 5 has been produced, it detaches the sealing film 28 circumferentially around the edge flanges 5.

Trays 18, which differ from one another in terms of the thickness of the shell part 1, the thickness of the collar 4 and/or the thickness of the shell part 1 and of the collar 4, can be processed by means of the same tools 8, 21, 22. This is due to the fact that the barrier film 17 is pressed onto the insides of the shell part 1 and collar 4 by applying a vacuum, and is connected thereto. Furthermore, this is due to the fact that the collars 4 circulate continuously with a uniform thickness and in a plane, as do the lower contact surfaces 25 and the upper contact surfaces 26 of the bottom and top tools 21, 22. As a consequence, the tools do not require any compensation during the processing of trays 18 having different thicknesses.

### LIST OF REFERENCE NUMERALS

1 Shell part
2 Bottom wall
3 Side walls
4 Collar
5 End flange
6 Tab
7 Adhesive surface
8 Bottom tool
9 Laminating station
10 Application
11 Cavity
12 Opening
13 Contact surface
14 Lower delimiting surface
15 Suction openings
16 Shell
17 Barrier film
18 Tray
19 Goods
20 Sealing station
21 Bottom tool
22 Top tool
23 Cavity
24 Opening
25 Lower contact surface
26 Upper contact surface
27 Heating apparatus
28 Sealing film

1. A method for producing packaging having a circumferential edge flange and a shell part, the method comprising:
providing the shell part comprised of a cellulose-containing material, wherein the shell part defines an opening at an upper end, a cavity at least partially formed by a bottom wall and side walls, and a continuously circumferential lower contact surface at a constant height around the opening of the cavity;
providing a collar including the circumferential edge flange comprised of one of cardboard, paperboard, corrugated board, and paper;
structuring at least one bottom tool to comprise a cavity configured to receive and support the shell part;
structuring at least one top tool to comprise a flat, continuously circumferential upper contact surface at a constant height and positioned corresponding to the lower contact surface of the shell part when the at least one top tool is positioned on top of the at least one bottom tool;
inserting the shell part into the cavity of the at least one bottom tool;
placing the collar comprising the edge flange on the lower contact surface of the at least one bottom tool;
covering the edge flange with a barrier film;
pressing the barrier film against a top side of the collar and of the shell part to form a tray;
filling the tray with goods;
positioning a sealing film above the tray so that it covers the edge flange;
pressing the sealing film using the at least one top tool in a continuously circumferential manner against a top side of the barrier film on the edge flange to seal the sealing film against the barrier film while preserving the edge flange of a uniform thickness, and
wherein the at least one bottom tool and the at least one top tool are configured to produce packaging from at least one of: (1) shell parts which differ in thicknesses; and (2) collars which differ thickness.

2. The method according to claim 1, wherein the tray comprises a shape that is one of: (a) round; and (2) polygonal.

3. The method according to claim 1, further comprising applying a vacuum to an underside of the shell part to press the barrier film against the top side of the collar and against the shell part.

4. The method according to claim 1, wherein the barrier film is pressed against the top side of the edge flange by the at least one top tool and is connected to the top side of the edge flange.

5. The method according to claim 1, wherein the at least one top tool further comprises a punch configured to press the barrier film against the top side of the shell part and the collar.

6. The method according to claim 5, wherein at least one of the shell part and the collar comprises an adhesive surface, and wherein the collar and the shell part are compressed by the punch of the top tool and are bonded to one another by activating the adhesive surface.

7. The method according to claim 1, wherein the at least one top tool further comprises a frame configured to press the barrier film against the top side of the edge flange.

8. The method according to claim 1, wherein the at least one bottom tool further comprises:
an upper bottom tool part comprising the circumferential lower contact surface;
multiple lower bottom tool parts defining multiple cavities for the shell part; and
multiple trays comprising shell parts that are produced with the same upper bottom tool part and the lower bottom tool part which matches the shell part.

9. The method according to claim 1, wherein the barrier film is heated by at least one of: (1) heat conduction; (2) radiation; and (3) convection.

10. The method according to claim 9, wherein the sealing film is heated by at least one of: (1) heat conduction; (2) radiation; and (3) by convection.

11. The method according to claim 1, wherein at least one of: (1) the shell part is formed by pressing a cellulose-containing flat material; and (2) the collar is formed from a blank made of one of cardboard, paperboard, corrugated board, paper, and any other foldable flat material.

12. The method according to claim 1, wherein the barrier film comprises at least one ply made of one of PET, PLA, EVOH, PA, PBT, PP, and PE.

13. The method according to claim 1, wherein at least one of: (1) the barrier film is produced from at least one biopolymer; (2) the barrier film is produced from at least one renewable raw material; and (3) the barrier film is produced from at least one compostable raw material.

14. The method according to claim 1, wherein the shell part and the collar are connected to one another before the barrier film is pressed against the collar and shell part and is connected thereto to form the tray.

15. The method according to claim 1, wherein at least one of the shell part and the collar is printed with a coating configured to influence adhesion of the barrier film onto the top side of the collar and to the shell part to form the tray.

16. The method according to claim 1, wherein the same at least one bottom tool and the same at least one top tool are configured to connect the shell part, the collar, and barrier film to form the tray.

17. The method according to claim 1, further comprising another bottom tool and another top tool configured to connect the filled tray to the sealing film.
